(19) United States
(12) Patent Application Publication
(10) Pub. No.: US 2004/0085727 A1
(43) Pub. Date: May 6, 2004

(54) Computer main body cooling system

(75) Inventor: Jong-Oh Kim, Seoul City (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd.

(21) Appl. No.: 10/412,412

(22) Filed: Apr. 14, 2003

(30) Foreign Application Priority Data
Oct. 31, 2002 (KR) 2002-67041

(51) Int. Cl. G06F 1/20

(52) U.S. Cl. 361/687; 361/697; 361/709; 165/104.33

(57) ABSTRACT

A computer main body cooling system enables an internal temperature thereof to be maintained at a desired level by continuously venting heat generated from a CPU and a power supply through a cooling system. The computer main body cooling system according to the present invention includes a CPU, a heat sink provided adjacent to the CPU, a CPU fan located in a side part of the heat sink, a power supply supplying power to the CPU and having an air vent permitting air to flow outside, and a power supply fan mounted on the power supply adjacent to the heat sink. Thus, the structure of a cooling system is simplified and optimized, not only to increase a cooling efficiency, but also to minimize noise occurrence due to fan rotation.

### CROSS-REFERENCE TO RELATED APPLICATIONS

This application claims the benefit of Korean Application No. 2002-67041, filed Oct. 31, 2002, in the Korean Intellectual Property Office, the disclosure of which is incorporated herein by reference.

### BACKGROUND OF THE INVENTION

1. Field of the Invention

The present invention relates to a computer, and more particularly, to a computer main body cooling system enabling an internal temperature thereof to be maintained at an appropriate level by continuously releasing heat generated from a CPU and a power supply via a cooling system.

2. Description of the Related Art

An LSI (Large-Scale Integration) or a VLSI (Very Large-Scale Integration) is located in an internal part of a computer main body, such as a CPU, to be actuated by an electrical signal processing a large amount of data accurately and promptly. A large amount of heat is inevitably generated from the CPU during processing the data in such a way that an internal temperature may be increased to an undesirable level by the heat generated from the CPU. If the CPU is overheated, a harmful influence is exerted on a computer system, and thus lowers the efficiency of the computer. As a result, in the computer main body, a cooling system is positioned to release, continuously, heat generated from the internal part.

A computer main body having a conventional cooling system, as shown in FIG. 1, comprises a casing 1 forming an external appearance, a main board 2 located in the inside of the casing 1, a CPU 3 located on the main board 2, a heat sink 4 located in the upper part of the CPU 3, a CPU fan 5 located in the upper part of the heat sink 4, a power supply 6 to supply power to the CPU 3 and the electronic parts of the computer, such as an HDD, DVD, FDD, GRAPHIC CARD and NETWORK CARD, and a power supply fan 7 mounted on the power supply 6.

According to the computer main body 10 with the above configuration, the CPU fan 5 that is used to cool the heated CPU 3 is located in the upper part of the heat sink 4 and blows air to the lower part thereof, to circulate the heat of the heat sink 4 by forced convection, which is called a blow in type. Recently, since the CPU 3 has become highly integrated and efficient, only one CPU fan 5 does not cool the main body sufficiently, and thus a separate case fan 8 has been mounted to exhaust a heat-exchanged air. Also, the power supply fan 7 that cools electronic parts of the power supply 6 does not exert a direct influence in cooling the CPU 3.

Thus, at least three cooling fans are needed and not only noise, but also an accompanying cost, are increased, and also, since the computer main body has a relatively large number of parts, the computer main body 10 is limited with respect to size reduction.

### SUMMARY OF THE INVENTION

Accordingly, it is an aspect of the present invention to provide a computer main body cooling system to solve the problem described above, by simplifying a cooling system and maximizing an accompanying cooling efficiency by optimizing a heat radiating structure of a CPU and a power supply.

According to an aspect of the invention, a computer main body cooling system comprises a CPU, a heat sink located adjacent to the CPU, a CPU fan located in a side part of the heat sink, a power supply supplying power to the CPU and having an air vent communicating with the outside, and a power supply fan mounted on the power supply adjacent to the heat sink cooperate to cool the CPU.

The computer main body cooling system may further comprise a heat sink cover mounted on the heat sink to prevent air that is heat-exchanged in the heat sink from diffusing. In addition, the heat sink cover may have a duct structure. Also, the heat sink cover may be connected with the power supply fan to form one body.

In addition, the power supply fan may be mounted opposite to the heat sink so that air blown by the CPU fan directly flows into the power supply fan.

In one aspect, the power supply has a duct structure to increase a cooling effect.

### BRIEF DESCRIPTION OF THE DRAWINGS

These and/or other aspects and advantages of the present invention will become apparent and more readily appreciated from the following description of embodiments, taken in conjunction with the accompanying drawings of which:

FIG. 1 is a perspective view partially illustrating a cooling system structure of a conventional computer main body;

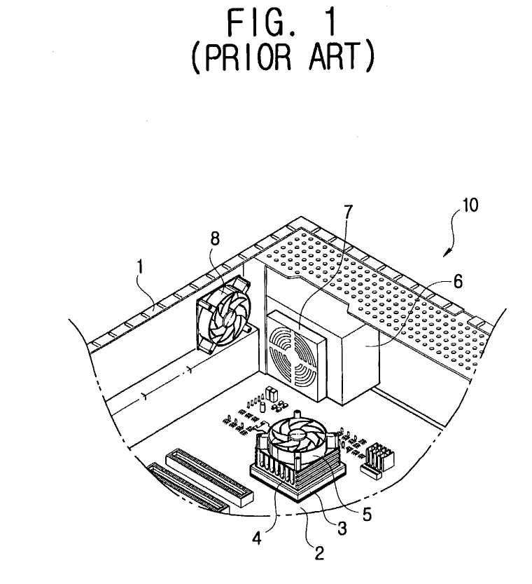

FIG. 2 is a plan view schematically illustrating a structure of a computer main body according to an embodiment of the present invention;

FIG. 3 is a perspective view partially illustrating a cooling system structure of the computer main body of FIG. 2;

FIG. 4 is a cross-sectional view taken along line IV-IV in FIG. 3;

FIG. 5 is a cross-sectional view illustrating a heat sink cover according to another embodiment of the present invention; and

FIG. 6 is a plan and cross-sectional view illustrating an internal structure of a power supply according to an embodiment of the present invention.

### DETAILED DESCRIPTION OF THE EMBODIMENTS

Configurations and functions of various structural elements of a main body of a computer are known to those skilled in the art, and thus are omitted. A cooling system of the main body of the computer in accordance with an embodiment of the present invention will be described below with reference to the accompanying drawings.

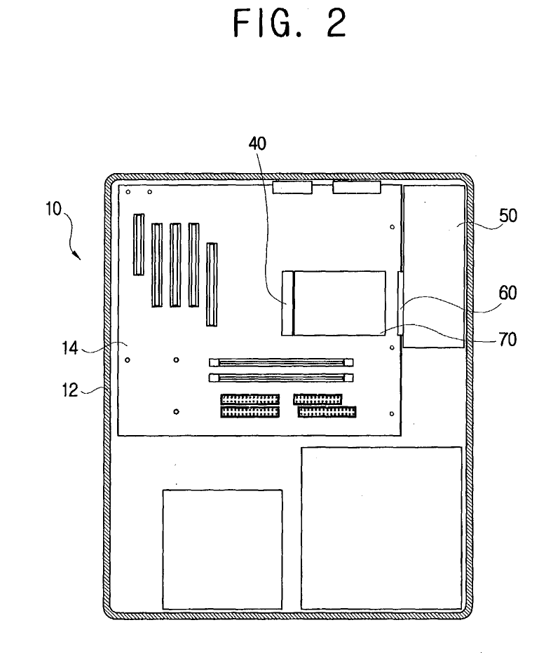

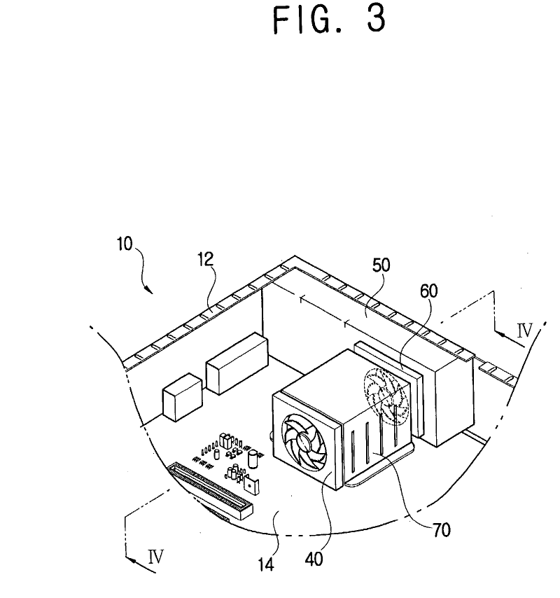

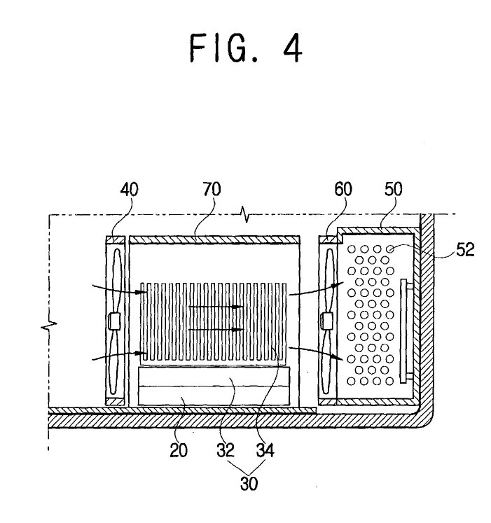

As shown in FIGS. 2 through 4, a computer main body 10 having a cooling system in accordance with an embodiment of the present invention comprises a CPU 20, a heat sink 30 located in an upper part of the CPU 20, a CPU fan 40 located in a side part of the heat sink 30, a power supply 50 supplying power to the CPU 20 and having an air vent 52 communicating with the outside, and a power supply fan 60 mounted on the power supply 50 adjacent to the heat sink 30.

The CPU 20 is fixed on a part of a main board 14 located in a casing 12 of the computer main body 10 and aids in controlling the computer system.

The heat sink 30 comprises a main part 32 conventionally joined to an upper plate of the CPU 20 and a cooling fin 34 quickly radiating heat transferred from the main part 32 to the atmosphere. The heat sink 30 comprises a material having high heat conductivity and has various structures as necessary. On an upper part of the heat sink 30 a heat sink cover 70 is mounted to cover the heat sink 30, and thus a high temperature air heat-exchanged in the heat sink 30 by a forced draft of the CPU fan 40 is prevented from diffusing into the inside of the computer main body 10, increasing cooling efficiency. The size and type of the heat sink cover 70 are variously changed according to the kind of the heat sink 30 applied. In one embodiment, a structure of a duct enabling air to flow quickly and smoothly may be used.

The CPU fan 40 is joined to a side part of the heat sink 30 by coupling and blows air to the heat sink 30. The air blown into the heat sink 30 is heat-exchanged during passing through the cooling fin 34, and thus cools the heat sink 30.

Air blown by the CPU fan 40 flows into the inside of the power supply 50 through the power supply fan 60 and is exhausted from the computer main body 10 through the air vent 52. The power supply fan 60 is mounted in a location where the air of the CPU fan 40 is drawn in and may be mounted opposite to the heat sink 30 so that the air of the CPU fan 40 can flow directly into the power supply fan.

Heat generated from internal electronic parts of the computer and heat generated from a chipset, the CPU 20, and the power supply 50 radiate outward through the air vent 52.

In the meanwhile, the CPU fan 40 blows air into the heat sink 30, and simultaneously, the power supply fan 60 blows the air away from the heat sink 30. Thus, the velocity of the air colliding with the cooling fin 34 of the heat sink 30 is increased, and the amount of the air passing through the cooling fin 34 is also increased. Also, a convective heat transfer coefficient and the amount of fluid that can be heat-exchanged with the cooling fin 34 are increased, increasing the cooling efficiency of the CPU 20.

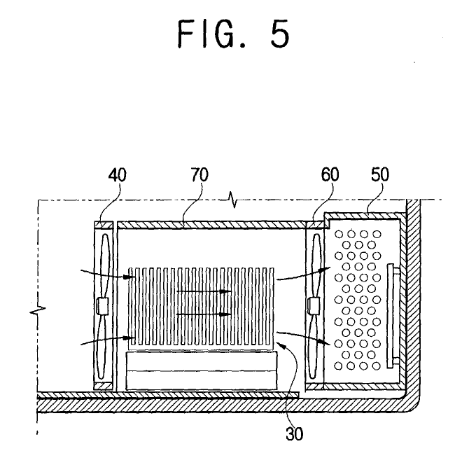

FIG. 5 is a cross-sectional view illustrating the heat sink cover of another embodiment according to the present invention. As shown in FIG. 5, the heat sink cover 70 is integrated with the power supply fan 60 as one body, and thus has a duct structure formed in one body extending from the heat sink 30 to the power supply 50.

Thus, when air blown by the CPU fan 40 is heat-exchanged in the heat sink 30 and then flows into the power supply 50 through the power supply fan 60, a partial diffusion of high temperature air between the heat sink 30 and the power supply fan 60 can be prevented.

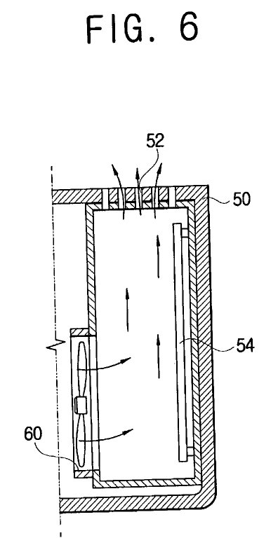

FIG. 6 is a plan and cross-sectional view illustrating an internal structure of the power supply according to an embodiment of the present invention. As shown in FIG. 6, the power supply 50 has a duct structure with a relatively long flow channel. Thus, air flowing through the power supply fan 60 which is mounted on one side of the power supply, exchanges heat with electronic parts 54 by convection, passes through the inside of the power supply 50, and then can be exhausted quickly outward through the air vent 52.

Thus, the convection heat transfer coefficient is increased, enabling the electronic parts 54 in the internal part of the power supply 50 to be cooled efficiently.

A cooling process according to an embodiment of the cooling system of the computer main body described above, is described briefly as follows. By operation of the CPU fan 40, air is blown into the heat sink 30, and the blown air is heat-exchanged, passing through the heat sink 30 and then being exhausted from the heat sink 30. In this embodiment, the heat sink cover 70 is mounted on the heat sink 30, and thus, high temperature air is prevented from diffusing into the internal part of the main body of the computer 10.

Air exhausted from the heat sink 30 flows into the power supply 50 when the power supply fan 60 operates simultaneously with the CPU fan 40. The air cools the electronic parts 54 by the conventional heat exchange, passes through the internal part of the power supply 50, and then finally is exhausted to the outside of the main body of the computer 10 through the air vent 52 that shunts air outside.

According to the embodiment of the present invention described above, the structure of a cooling system is simplified and optimized, not only to decrease a size of a computer main body, but also to increase cooling efficiency.

Also, by using only two cooling fans, the number of parts and an accompanying cost are decreased compared with existing structures.

Further, a heat sink and a power supply have a duct structure, and thus heat-exchanged high temperature air is prevented from diffusing into the internal part of the computer main body. Thus, stability of electronic parts in the computer can be increased.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A computer main body having a cooling system, comprising:
a CPU;
a heat sink provided adjacent to the CPU;
a CPU fan provided in a side part of the heat sink;
a power supply supplying power to the CPU and having an air vent permitting air to flow outside of the computer main body; and
a power supply fan mounted on the power supply adjacent to the heat sink.

2. The computer main body according to claim 1, further comprising a heat sink cover mounted on the heat sink to prevent air heat-exchanged in the heat sink from diffusing.

3. The computer main body according to claim 2, wherein the heat sink cover has a duct structure.

4. The computer main body according to claim 3, wherein the heat sink cover is integrated with the power supply fan in one body.

5. The computer main body according to claim 1, wherein the power supply fan is mounted opposite to the heat sink so that air blown by the CPU fan flows directly into the power supply fan.

6. The computer main body according to claim 2, wherein the power supply fan is mounted opposite to the heat sink so that air blown by the CPU fan flows directly into the power supply fan.

7. The computer main body according to claim 1, wherein the power supply has a duct structure.

8. The computer main body according to claim 1, wherein the CPU fan has an axis of rotation parallel to the surface of the CPU.

9. The computer main body according to claim 1, wherein the heat sink comprises a plurality of cooling fins, and the CPU fan has an axis of rotation perpendicular to a direction of the cooling fins.

10. A computer main body cooling system for a computer having a CPU, comprising:
a side fan-cooled heat sink provided adjacent to the CPU; and
an outside air-vented, fan-cooled power supply supplying power to the CPU.

11. The computer main body cooling system according to claim 10, further comprising a power supply fan mounted on the power supply adjacent to the heat sink.

12. The computer main body cooling system according to claim 10, further comprising a heat sink cover mounted on the heat sink to prevent air heat-exchanged in the heat sink from diffusing.

13. The computer main body cooling system according to claim 12, wherein the heat sink cover has a duct structure.

14. The computer main body cooling system according to claim 13, wherein the heat sink cover is integrated with the power supply fan in one body.

15. The computer main body cooling system according to claim 10, wherein the power supply fan is mounted opposite to the heat sink so that air blown by the CPU fan flows directly into the power supply fan.

16. The computer main body cooling system according to claim 12, wherein the power supply fan is mounted opposite to the heat sink so that air blown by the CPU fan flows directly into the power supply fan.

17. The computer main body cooling system according to claim 10, wherein the power supply has a duct structure.

18. The computer main body cooling system according to claim 10, wherein the CPU fan has an axis of rotation parallel to the surface of the CPU.

19. The computer main body cooling system according to claim 10, wherein the heat sink comprises a plurality of cooling fins, and the CPU fan has an axis of rotation perpendicular to a direction of the cooling fins.

20. The computer main body cooling system according to claim 19, wherein a fluid passes through the cooling fins to increase a cooling efficiency.
